(19) United States
(12) Patent Application Publication
(10) Pub. No.: US 2010/0016490 A1
(43) Pub. Date: Jan. 21, 2010

(54) POLYMERS

(75) Inventors: Mario Scholz, Gruendau (DE); Kai Schumacher, Hofheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/524,612

(22) PCT Filed: Jan. 25, 2008
(86) PCT No.: PCT/EP2008/050912

§ 371 Date: Jul. 27, 2009

(30) Foreign Application Priority Data
Feb. 28, 2007 (DE) 102007010212.9

(51) Int. Cl. C08K 9/10; C08K 3/22

(52) U.S. Cl. 524/413

(57) ABSTRACT

Polymers, such as silicone rubber, contain a pyrogenically produced titanium dioxide encapsulated with silicon dioxide, as filler, and a process for improving the stability of polymers with regard to the action of heat and flames.

The invention relates to polymers and to a process for improving the stability of polymers with regard to the action of heat and flames.

It is known to use pyrogenically produced titanium dioxide in silicone rubber (Schriftenreihe Pigmente No. 56 Degussa Aktiengesellschaft 1989, page 27).

The invention provides polymers which are characterised in that they contain a pyrogenically produced titanium dioxide encapsulated with silicon dioxide, as filler.

The invention further provides a process for improving the stability of polymers with regard to the action of heat and flames, which is characterised in that a pyrogenically produced titanium oxide encapsulated with silicon dioxide is added to the polymers before or during processing.

The pyrogenically produced titanium oxide encapsulated with silicon dioxide can be a powder, consisting of particles with a core of titanium dioxide and a shell of silicon dioxide, which is characterised in that it
has a silicon dioxide content of between 0.5 and 40 wt. %,
has a BET surface area of between 5 and 300 m²/g, and
consists of primary particles which have a shell of silicon dioxide and a core of titanium dioxide.
A powder of this type is known from DE 102 60 718.

The silicon dioxide content of the powder used according to the invention is between 0.5 and 40 wt. %. With values below 0.5 wt. %, it is not guaranteed that the silicon dioxide shell is completely closed.

The BET surface area of the powder used according to the invention is determined in accordance with DIN 66131.

By primary particles are meant extremely small particles that cannot be further comminuted without breaking chemical bonds.

These primary particles can intergrow to aggregates. Aggregates are distinguished by the fact that their surface area is smaller than the sum of the surface areas of the primary particles of which they consist. Furthermore, aggregates are not completely comminuted to primary particles on dispersing. Powders with a low BET surface area used according to the invention can occur wholly or predominantly in the form of non-aggregated primary particles, whilst powders with a high BET surface area used according to the invention have a higher degree of aggregation or are completely aggregated.

The aggregates preferably consist of primary particles which are intergrown over their silicon dioxide shell.

Furthermore, the powder used according to the invention can preferably have a silicon dioxide content of 1 to 20 wt. %.

The ratio of the rutile/anatase modifications of the titanium dioxide core of the powder used according to the invention can be varied within wide limits. Thus the ratio of the rutile/anatase modifications can be from 1:99 to 99:1, preferably 10:90 to 90:10.

Furthermore, the powder used according to the invention can preferably have a BET surface area of 40 to 120 m²/g, particularly preferably between 60 und 70 m²/g.

The powder used according to the invention can be produced in that a vaporisable silicon compound and a vaporisable titanium compound, corresponding to the later desired ratio of SiO₂ and TiO₂ in the product, are mixed, vaporised at temperatures of 200° C. or less, and transferred by means of an inert gas stream together with hydrogen and air or air enriched with oxygen, to the central tube (core) of a known burner, the reaction mixture is ignited at the mouth of the burner and introduced together with secondary air, burned in a cooled fire tube, then the titanium dioxide powder encapsulated with silicon dioxide separated from the gaseous reaction products and freed from adhering hydrogen chloride optionally in moist air, wherein the ratio of
primary air to secondary air is greater than 0.3,
core hydrogen to secondary air is greater than 1,
titanium dioxide precursor to secondary air is greater than 0.5.

It was found that the powder used according to the invention is only obtained if all the stated parameters are met. In the event of deviations, powders and powder mixtures not according to the invention are obtained.

The type of vaporisable titanium compound in the production of the powder used according to the invention is not restricted. Titanium tetrachloride can preferably be used.

The type of vaporisable silicon compound is likewise not restricted. Silicon tetrachloride can preferably be used.

Silicones, such as for example silicone rubber, silicone oil, synthetic and/or natural rubbers or rubber, can be used as polymers.

Chemical compounds which contain at least one —Si—O—Si bond in a molecule, are referred to as silicones, wherein the silicon atom combines the two remaining bonds with organic groups. The synthetically produced linear polyorganosiloxanes are generally referred to as silicone oil. In the synthesis of the silicone polymers, the chain length and the type of substituents referred to in the following as “R”, is changeable in a varied way.

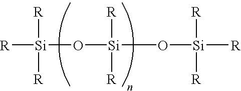

R=substituent

If the radical “R” is a methyl group, this is then the quantitatively most significant silicone polymer polymethylsiloxane. Desired material properties of the polymers can be achieved by suitable combination of various substituents or specific incorporation of reactive groups into the polymer chain.

Polymers of this type can be:

### 1. Thermosets

phenolic and melamine resins
polyester resins

### 2. Thermoplastics

PP
PE
PS
PVC

### 3. Thermoplastic Elastomers

copolyesters
polyether block amides
styrene block copolymers

For selection of the silicone polymers for the production of silicone elastomers, the most varied types of polymer of extremely different reactivity are possible. The type and reactivity of the present polymer is very important in selecting the silica used for reinforcement purposes.

A distinguishing feature between the various silicone systems is the vulcanisation temperature. HTV (high temperature vulcanising) silicone rubber is vulcanised at temperatures above 100° C.

In RTV (room temperature vulcanising) silicone rubber, as is obvious from the name, crosslinking is carried out at room temperature.

Characterisation of the chemical crosslinking reaction is important to show a further distinguishing feature.

With rubber, vulcanisation initiated with peroxides can be carried out. This peroxide-initiated crosslinking proceeds particularly readily with vinyl group-containing polymers.

The crosslinking principle of a polyaddition in which a so-called hydrosilylation reaction proceeds by insertion of a Si—H group into an olefinic double bond, can be carried out both at high and also at low temperature. Since the polymers used therefor have a clearly lower viscosity than those crosslinked with peroxides, this silicone system is also referred to as liquid silicone rubber (LSR).

A further usable type of crosslinking is based on the polycondensation reaction, in which crosslinking takes place by reacting two molecules, with splitting off of a small condensate molecule.

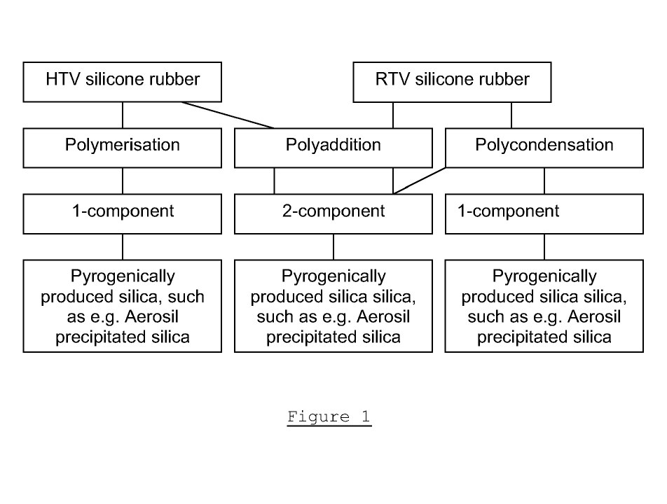

The silicone types that can be used according to the invention can, as shown in FIG. 1, be grouped together.

In 1-component (1C) systems, vulcanisation is initiated by moisture from the ambient air and/or from the substrate. Depending on the type of sealant, reaction products are split off and released. The rate of crosslinking is dependent both on the thickness of the joint and on the atmospheric humidity or temperature. In the 2-component (2C) systems, the base polymers provided virtually without exception with fillers (component A) are packed separately from the crosslinking agent (component B).

With the exception of the RTV 1C silicone rubber in which, due to the comparatively high moisture content of the precipitated silicas, only pyrogenically produced silica, such as for example Aerosil, can be used, both types of silica are suitable for all other crosslinking systems. Table 1, at the bottom, shows typical silicone rubber applications and the requirements linked therewith for the silica used which serves as filler.

TABLE 1

| | | Requirements for |
|---|---|---|
| System | Application | the silica used |
| HTV silicone rubber | Extruded parts | good reinforcement |
| RTV-1 silicone rubber | Sealants | thickening |
| | | good reinforcement |
| RTV-2 silicone rubber | Impression materials | low thickening |
| | Casting materials | good reinforcement |
| LSR liquid silicone | Extruded parts | low thickening |
| rubber | Injection mouldings | good reinforcement |
| | | high transparency |
| Synthetic rubber | Conveyor belts | |
| | Cable sheathing | |
| | Rollers | |
| | Seals | |
| Fluororubber | Seals | |

The powder according to the invention used, of the titanium dioxide encapsulated with silicon dioxide can be added to the polymers for example before or during vulcanisation or crosslinking.

The pyrogenically produced titanium dioxide encapsulated with silicon dioxide can be added to the polymers in a quantity of 0.05 to 20 wt. %, preferably 0.5 to 2.5 wt. %.

The process according to the invention has the advantage that the polymers have an improved stability with regard to the action of heat and flames. This means that the splitting off of organic materials at higher temperatures is clearly reduced.

An improved flame protection effect is thereby additionally achieved.

### EXAMPLES

### Analytical Determinations

The content of titanium dioxide and silicon dioxide is determined by means of X-ray fluorescence analysis.

The BET surface area is determined in accordance with DIN 66131.

The dibutyl phthalate absorption (DBP index) is measured with a RHEOCORD 90 device from Haake, Karlsruhe. For this, 16 g of the silicon dioxide powder are fed to an accuracy of 0.001 g into a mixing chamber; this is sealed with a lid and dibutyl phthalate is added via a hole in the lid at a given metering rate of 0.0667 ml/s. The kneader is operated at a motor speed of 125 revolutions per minute. On achieving the torque maximum, the kneader and the DBP metering are automatically switched off. The DBP absorption is calculated from the quantity of DBP consumed and the weighed quantity of the particles as follows:

DBP index (g/100 g)=(consumption of DBP in g/weighed quantity of powder in g)×100.

The pH is determined in accordance with DIN ISO 787/IX, ASTM D 1280, JIS K 5101/24.

### Example 1

### Production of the TiO₂ Encapsulated with SiO₂

3.86 kg/h TiCl₄ and 0.332 kg/h SiCl₄ are vaporised in a vaporiser at approx. 200° C. The vapours are mixed, by means of nitrogen, together with 1.45 Nm³/h hydrogen and 7.8 Nm³/h dried air in the mixing chamber of a burner of known construction, and fed via a central tube, at the end of which the reaction mixture is ignited, to a water-cooled flame tube and there burned. In addition, 0.9 Nm³/h hydrogen and 25 Nm³/h air are fed to the flame tube via a jacketed tube concentrically surrounding the central tube.

The powder produced is then separated off in a filter. Adhering chloride is removed by treating the powder with moist air at approx. 500-700° C. It contains 92 wt. % titanium dioxide and 8 wt. % silicon dioxide.

Examples 2 to 5 are carried out as in example 1. The batch sizes and the experimental conditions are given in Table 1; the physical-chemical properties of the powder according to the invention are given in Table 2.

TEM-EDX evaluations of the powders of examples 1 to 5 show a largely aggregated powder with complete silicon dioxide shell and a titanium dioxide core. There are aggregates present, wherein the primary particles are intergrown over the silicon dioxide shell. The BET surface area is 66 m²/g. The X-ray diffraction analysis shows a rutile-anatase ratio in the core of 26:74.

The DBP absorption of the powder according to the invention of examples 1 to 3 is low or not measurable. This indicates a low degree of intergrowth.

### Examples

### Applications in Silicone Rubber

Using the titanium dioxide encapsulated with silicon dioxide according to example 1 as filler (not as additive!!!!) in liquid silicone rubber in comparison with AEROSIL® R 812S, it was surprisingly shown that the vulcanisates are clearly more stable regarding the influence of heat. At a storage temperature of 250° C., the Shore A hardness remained virtually unchanged over a storage time of 21 days, whereas the vulcanisates with R 812S as filler became completely embrittled even after a storage period of one day at 250° C., which can be recognised in the sharp rise in the Shore A hardness to values of approx. 90 and more. In addition, the clearly higher weight loss of the vulcanisates can be recognised if R 812S is used.

### Procedure:

Testing of the silica according to the invention in LSR silicone rubber was carried out according to the following specification:

In a planetary dissolver, 20% silica is incorporated at slow speed ( 50/500 rpm planetary mixer/dissolver disk) in organopolysiloxane (Silopren U 10 GE Bayer Silicones). As soon as the silica is completely wetted, a vacuum of approx. 200 mbar is applied and dispersed for 30 minutes at 100 rpm of the planetary mixer and 2000 rpm of the dissolver (cooling with tap water). After cooling, crosslinking of the base mixture can take place. After incorporation, the mixture forms a low-viscosity, free-flowing composition. After the thirty minute dispersion, the viscosity is somewhat reduced. 340 g of the base mixture are weighed in a stainless steel cup. 6.00 g inhibitor (2% pure ECH in silicone polymer U 1) and 0.67 g platinum catalyst solution and 4.19 g Silopren U 730 are weighed into the mixture in succession and homogenised and deaerated at a speed of n=500 rpm.

### Vulcanisation:

4×50 g or 2×100 g of the mixture are required for vulcanisation of the 2 mm vulcanisates. In the press, the sheets are then pressed for 10 minutes at a pressure of 100 bar and a temperature of 120° C. 120 g of the mixture are required for vulcanisation of the 6 mm vulcanisates. In the press, the sheets are pressed for 12 minutes at a pressure of 100 bar and a temperature of 120° C. The vulcanisates are then revulcanised in the oven for 4 hours at 200° C.

### Heat Ageing:

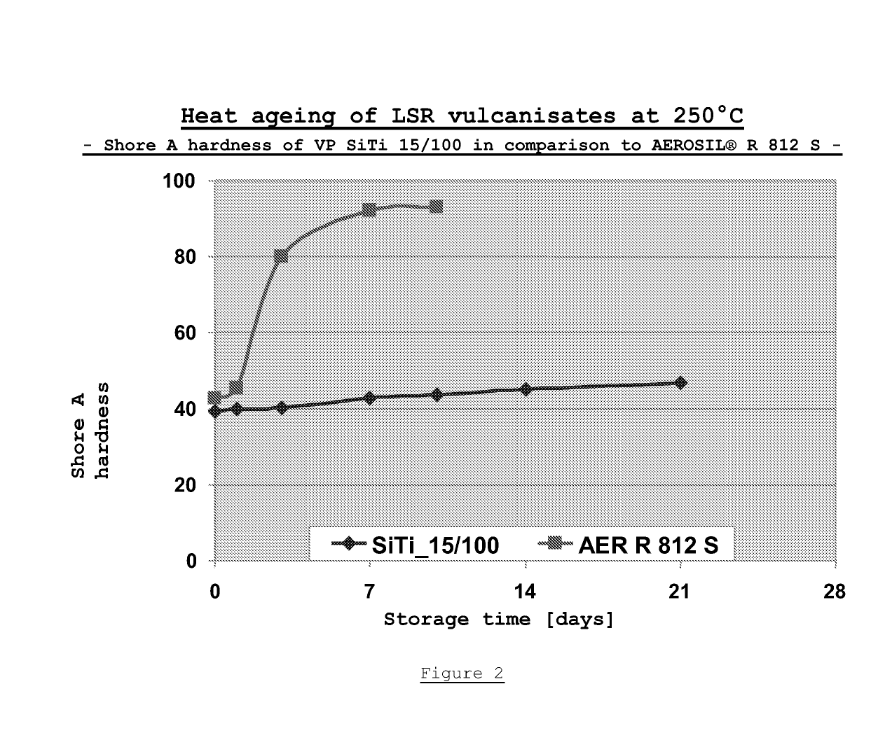

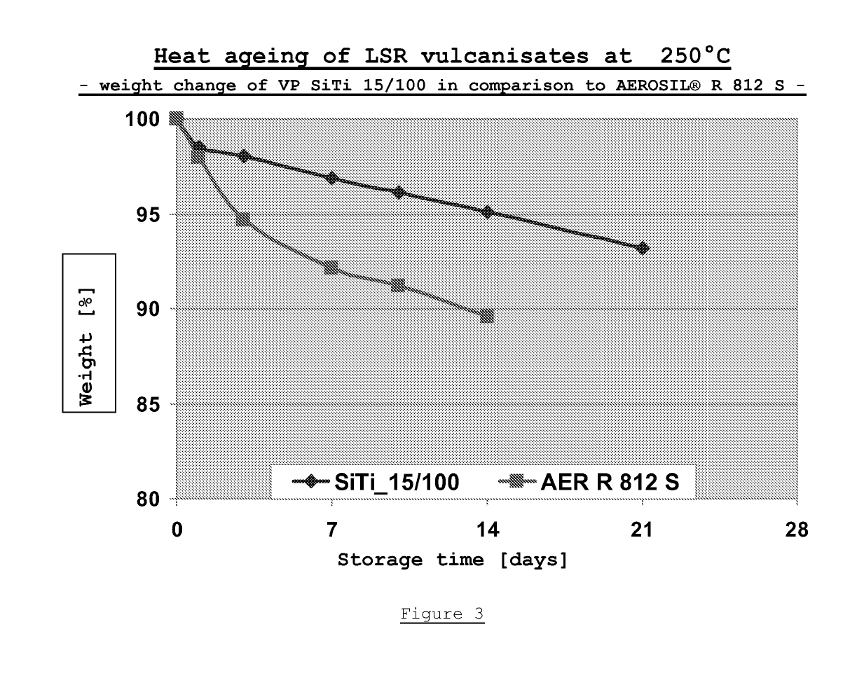

The vulcanisates were conditioned in a circulating air oven at 250° C., and the course of the Shore A hardness was measured over the storage time of a total of 3 weeks (FIG. 2). In addition, the weight loss was also recorded. It can thereby be seen that the vulcanisates with R 812S have a clearly higher weight loss based on decomposition (FIG. 3).

TABLE 1
Experimental conditions in the production of powders 1 to 5

| | | | | | | | | Inert | Inert |
|---|---|---|---|---|---|---|---|---|---|
| | | | Vaporiser | H₂ | H₂ | Air | Secondary | gas | gas |
| | TiCl₄ | SiCl₄ | temp. | core | jacket | core | air | core | jacket |
| Example | kg/h | kg/h | ° C. | Nm³/h | Nm³/h | Nm³/h | Nm³/h | Nm³/h | Nm³/h |
| 1 | 3.86 | 0.4 | 140 | 1.45 | 0.9 | 7.7 | 25 | 0.2 | 0.5 |
| 2 | 3.86 | 0.2 | 135 | 1.45 | 0.9 | 7.7 | 25 | 0.2 | 0.5 |
| 3 | 3.86 | 0.11 | 137 | 1.45 | 0.9 | 7.7 | 25 | 0.2 | 0.5 |
| 4 | 3.86 | 0.81 | 131 | 1.45 | 0.9 | 8 | 20 | 0.2 | 0.5 |
| 5 | 3.86 | 1.15 | 133 | 1.45 | 0.9 | 8.3 | 20 | 0.2 | 0.5 |

TABLE 2
Physical-chemical data of powders 1 to 5

| | TiO₂ | SiO₂ | | | DBP |
|---|---|---|---|---|---|
| | content | content | BET | pH | index |
| Example | wt. % | wt. % | m²/g | | g/100 g |
| 1 | 92.67 | 7.33 | 66 | 3.69 | 121 |
| 2 | 96.19 | 3.8 | 62 | 3.98 | n.d.⁽²⁾ |
| 3 | 97.83 | 2.13 | 57 | 4.27 | n.d.⁽²⁾ |
| 4 | 87.29 | 12.67 | 59 | 3.75 | —⁽³⁾ |
| 5 | 80.85 | 19.15 | 68 | 3.89 | — |

⁽²⁾n.d. = not determinable;
⁽³⁾— = not determined;

1. Polymers, characterised in that they contain a pyrogenically produced titanium oxide encapsulated with silicon dioxide as fillers.

2. Process for improving the stability of polymers with regard to the action of heat and flames, characterised in that a pyrogenically produced titanium dioxide encapsulated with silicon dioxide is added to the polymers before or during processing.

3. Process according to claim 1, characterised in that the pyrogenically produced titanium dioxide encapsulated with silicon dioxide is added to the polymers before or during vulcanisation or crosslinking.
